(19) United States
(12) Patent Application Publication
(10) Pub. No.: US 2016/0309697 A1
(43) Pub. Date: Oct. 27, 2016

(54) Glue Trap Barrier

(71) Applicant: Giancarlo Thomas Roma, Brooklyn, NY (US)

(72) Inventor: Giancarlo Thomas Roma, Brooklyn, NY (US)

(21) Appl. No.: 14/696,190

(22) Filed: Apr. 24, 2015

(51) Int. Cl. A01M 23/00; A01M 99/00

(52) U.S. Cl. CPC A01M 23/005; A01M 99/00

(57) ABSTRACT

This patent describes a longer/variable length glue trap barrier that consists of multiple substrates connected to one another by perforation, each with a layer of non-drying glue extending completely from end to end along the longest dimension of the substrate. The barrier can be sized to fit a desired space by tearing along the perforation, and multiple barriers can be attached to one another for extended length and custom configurations. If and when a pest is caught in one of the individual traps within the longer barrier, the perforation allows for easy removal and disposal of the trap, and a new one to be put in its place, restoring the continuity of the barrier.

### FIELD OF INVENTION

This invention relates most broadly to the field of rodent and pest control and, more specifically, to a longer/variable length glue trap that can be implemented as a barrier.

### BACKGROUND OF INVENTION

The prior art in the field of glue traps consists primarily of standalone traps consisting of a layer of non-drying glue deposited on a paper board or plastic tray. The glue takes up most of the middle of the substrate but leaves the edges of the substrate without any glue. Even when the traps are designed to connect to one another (usually with a rudimentary paper tab), there is a fairly sizeable space between the individual traps where no glue is present. The disadvantage to this system is that it allows the rodent to encounter and even cross the trap without stepping on or being caught in the glue. The connective tabs are also often cumbersome, making the task of connecting the traps difficult and time-consuming.

Moreover, these prior art standalone traps are difficult to use in hard-to-reach places, like under a stove or refrigerator. Often, traps are placed towards the back of a hard-to-reach area, even completely against the wall (traditionally a high-traffic zone for rodents and other pests). In order to both initially place and eventually remove a trap, one must awkwardly reach one's entire arm along the floor (under the stove or refrigerator), which is usually a space covered with dust, cobwebs, and the like. This method becomes even more unpleasant when a mouse has been caught in a trap, and one must blindly reach along the floor in order to locate the trap and remove it. The disadvantage to this system is that it is inefficient and undesirable for the user, in that it involves direct and extended contact with unpleasant spaces.

### OBJECTS AND SUMMARY OF THE INVENTION

It is the object of this invention to create a longer/variable length glue trap that serves as an effective barrier by which to catch rodents and other pests. This is achieved through the long length of the chain of substrates topped with glue, as well as the design of the glue extending completely from edge to edge along the long dimension of the traps. Additionally, once a rodent is caught in one of the individual traps within the longer chain, the continuity of the barrier can be easily restored by removing said trap (by tearing along the perforation) and placing a new trap in its place such that it overlaps very slightly along the shorter dimension of the traps on either side, thus utilizing the glue on the top of the traps as an adhesive.

Another object is to create a glue trap barrier of longer/variable length that comes pre-assembled via the perforations and can be sized to fit nearly any space tearing at a selected perforation, and configured to almost any shape or length by connecting multiple barriers together.

Another object is to create an effective method for laying down a barrier for rodents in hard-to-reach places. In this iteration, the chain of traps is sized to fit the length of the area and subsequently slid into place (under a stove, for example). In order to lay down the barrier in this way, as well as eventually remove it, one need only touch the glue-less edges of the individual trap in the chain that is closest to the user (farthest from the wall) and simply slide the entire barrier into or out of the desired area. This method is helpful and effective because it allows the traps closest to the wall (farthest from the user) to be placed and removed without having to reach one's hand into an often unpleasant and unclean area, and also increases the chances of catching a rodent in a high-traffic area by creating a barrier.

Yet another object is to create an accordion-style folding method for the individual traps (as part of the larger chain), wherein the individual traps fold one on top of the next, hinging at the perforations, allowing for maximum use of packaging space and ease of storage.

### BRIEF DESCRIPTIONS OF DRAWINGS

FIG. 1 is a top plan view of the top of the longer/variable length glue trap

FIG. 2 is a top plan view of the top of the longer/variable length glue trap

FIG. 3 is a side view of a cross-section of the longer/variable length glue trap

FIG. 4 is a side view of the accordion-style packaging of the longer/variable length glue trap.

FIG. 5 contains four top plan view drawings

FIG. 6 is a top plan view of the top of the longer/variable length glue trap barrier

FIG. 7 is a top plan view of the top of an extended length glue trap barrier

FIG. 8 is a top plan view of the top of an extended length glue trap barrier

FIG. 9 is a top plan view of the top of a glue trap barrier

FIG. 10 is a top plan view of the top of a glue trap barrier

### DETAILED DESCRIPTION OF INVENTION

The following description of the accompanying drawings will further highlight the objects and advantages of the invention:

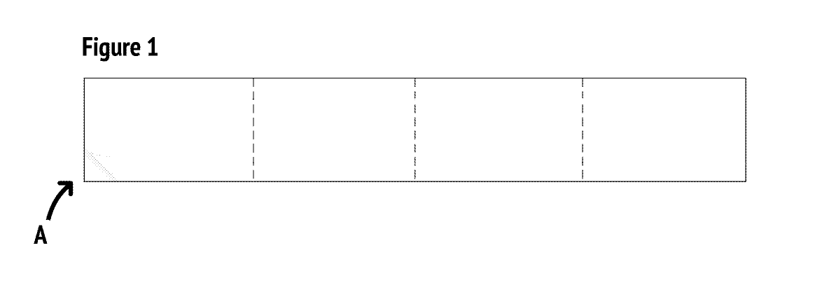

FIG. 1 is a top plan view of the top of the longer/variable length glue trap as it would appear completely folded out from the packaging, with the release layer still attached. The release layer is denoted A.

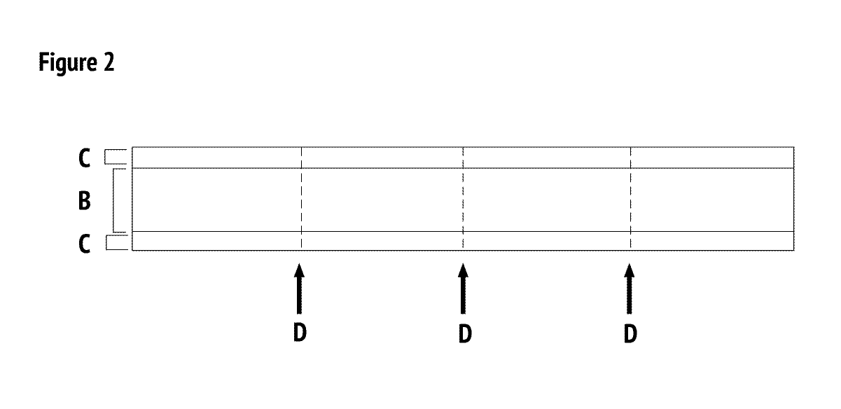

FIG. 2 is a top plan view of the top of the longer/variable length glue trap as it would appear completely folded out from the packaging, after the release layer has been removed. The area where glue is deposited on the connected boards is denoted B and the two thin strips where glue is not present (for ease of handling) are denoted C. The perforations between the individual boards are each denoted D.

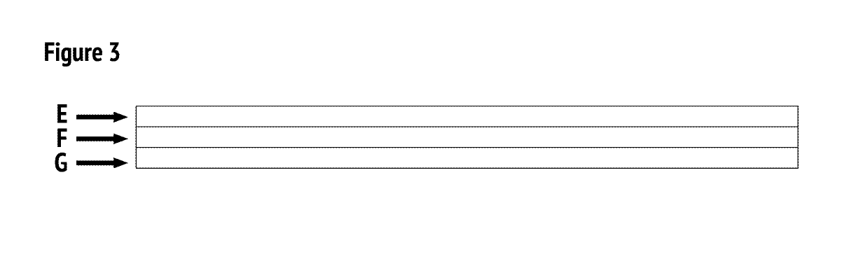

FIG. 3 is a side view of a cross-section of the longer/variable length glue trap, showing the layers of the trap, stacked vertically (although not necessarily to scale). The layers are denoted as follows:
E: Release layer
F: Non-drying glue
G: Substrate

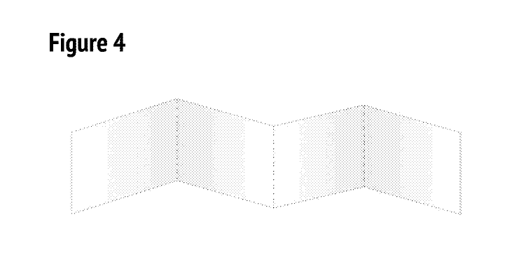

FIG. 4 is a side view of the accordion-style packaging of the longer/variable length glue trap, wherein the individual boards fold one on top of the next, hinging at the perforation.

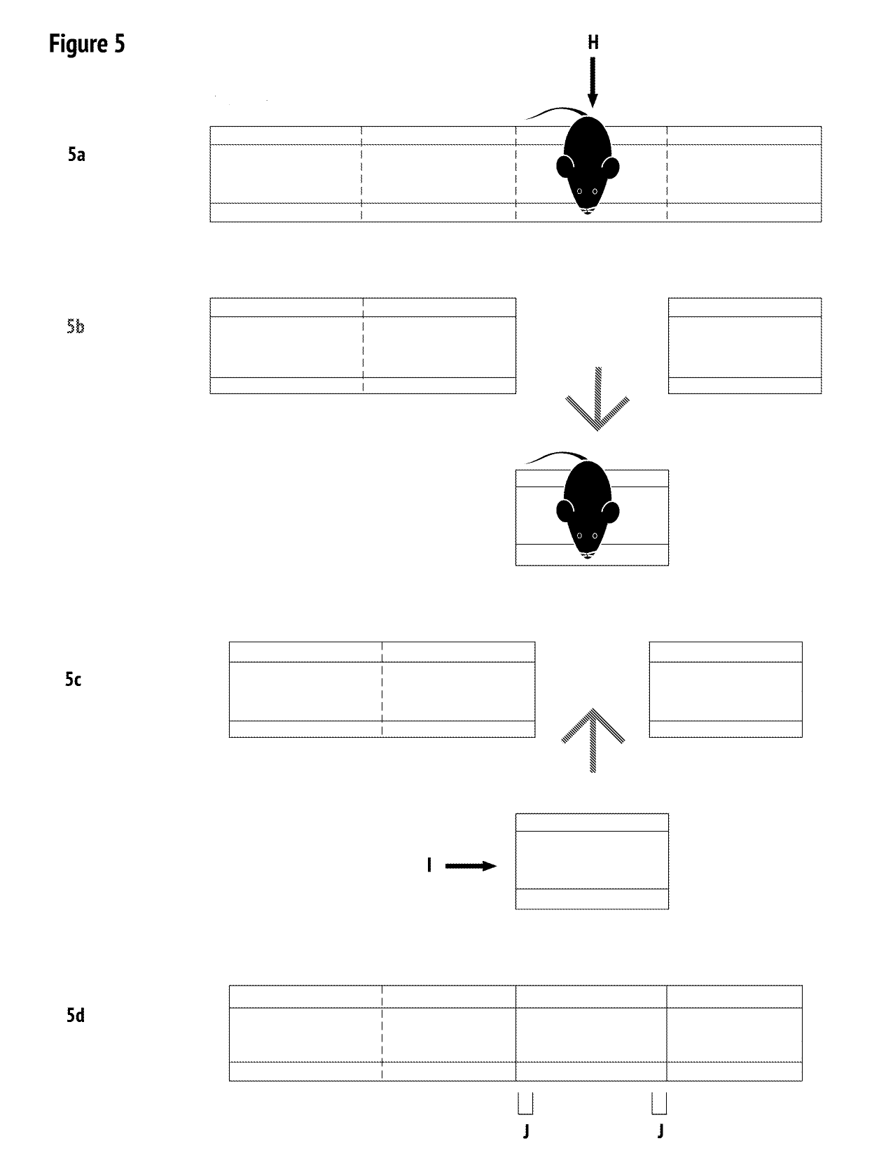

FIG. 5 contains four top plan view drawings that demonstrate how to replace an individual trap within the chain after a mouse is caught in said individual trap.

FIG. 5a shows a mouse caught in one of the individual glue traps, denoted H, as part of the longer glue trap barrier.

FIG. 5b shows the removal individual trap that contains the mouse by tearing along the perforation.

FIG. 5c shows the adhering of the new individual trap (in place of the old individual trap), denoted I, to the longer glue trap barrier by placing the new individual trap such that it slightly overlaps with the traps on either side, in order to maintain the continuity of the glue trap barrier.

FIG. 5d shows the resulting longer glue trap barrier, with restored continuity. Note that the chain is very slightly shorter than it was in FIG. 5a, but only by the size of the areas of overlap between the new trap and the surrounding traps, which is denoted J.

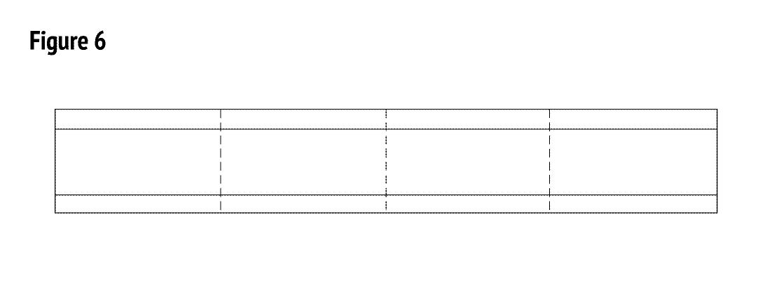

FIG. 6 is a top plan view of the top of the longer/variable length glue trap barrier oriented in a straight line, its most classic iteration.

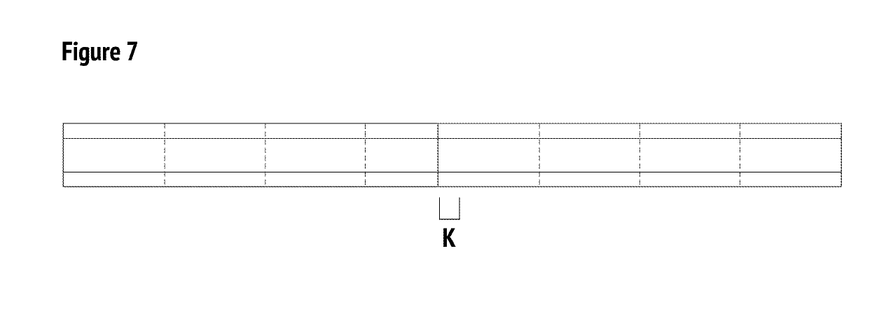

FIG. 7 is a top plan view of the top of an extended length glue trap barrier oriented in a straight line. This configuration is achieved by adhering one single chain to another by slightly overlapping the first individual trap of the second chain with the last individual trap of the first chain. The overlap is denoted K.

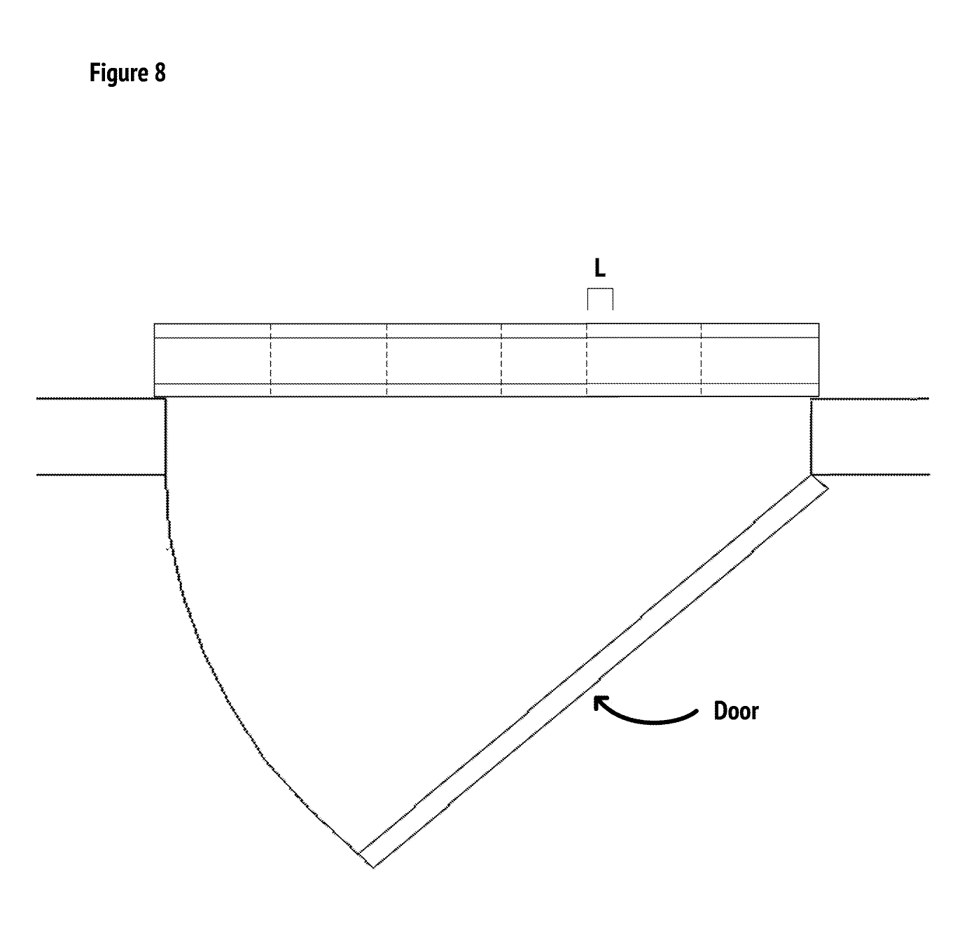

FIG. 8 is a top plan view of the top of an extended length glue trap barrier oriented in a straight line, custom sized to fit specific space, such as a doorway. This configuration is achieved by adhering one single chain to another by overlapping the first individual trap of the second chain with the last individual trap of the first chain by the amount necessary for the resulting barrier to exactly fit the given space. The overlap is denoted L.

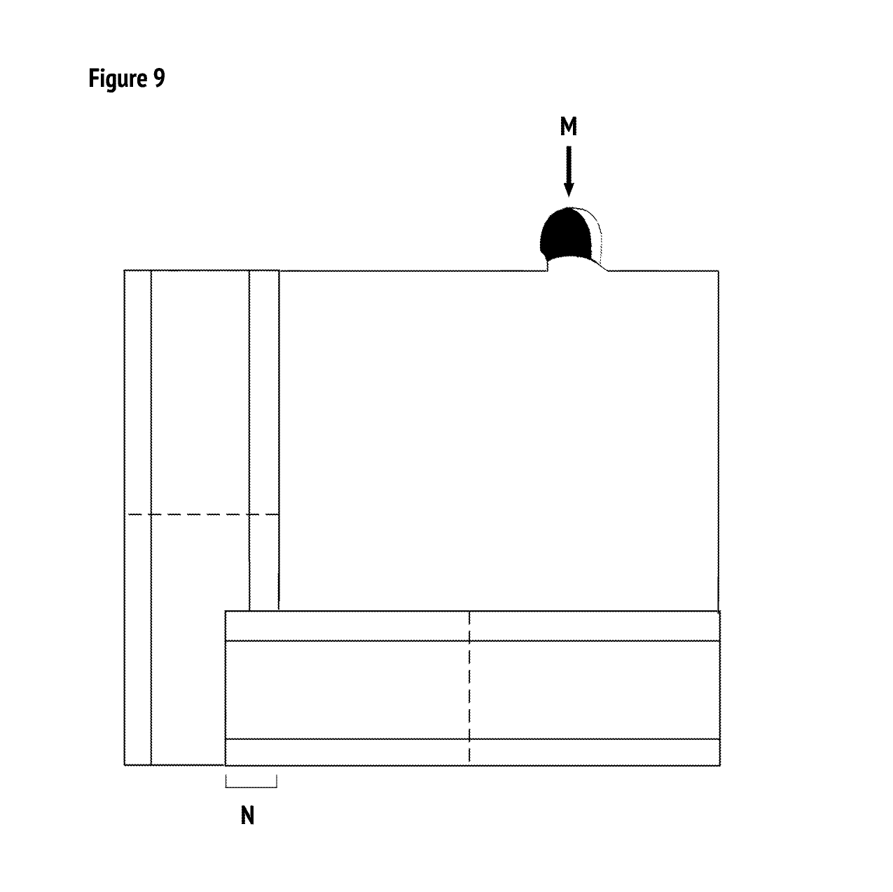

FIG. 9 is a top plan view of the top of a glue trap barrier oriented in an L-shape, specifically for use in a corner, most likely to surround a known mouse hole, denoted M. This configuration is achieved by orienting two chains perpendicularly, and slightly overlapping the first individual trap of the second chain with the last individual trap of the first chain. The overlap is denoted N.

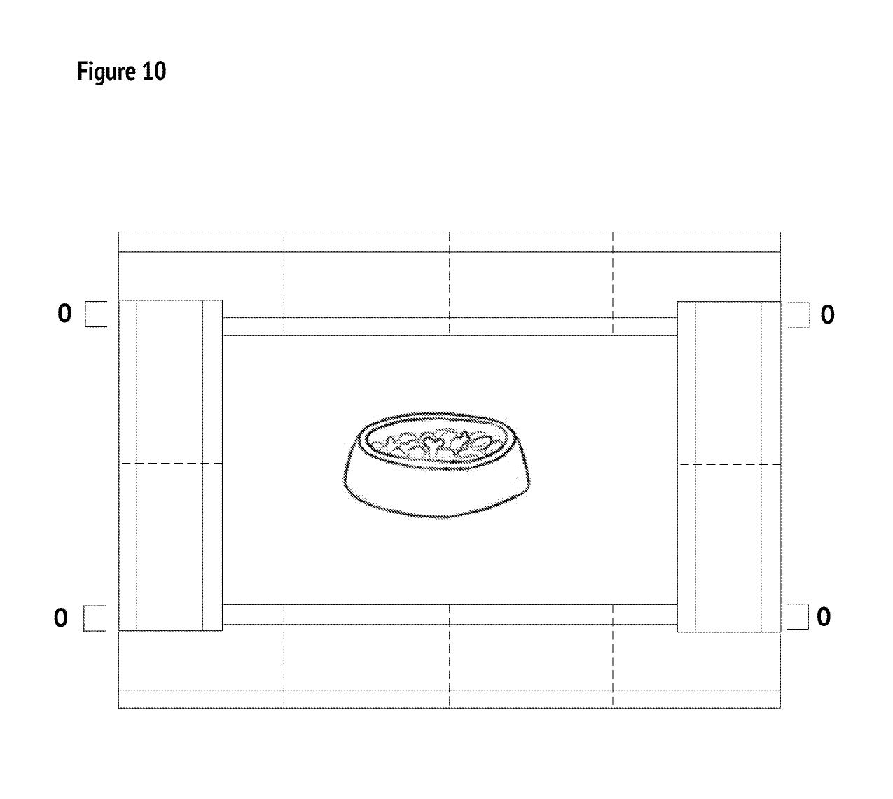

FIG. 10 is a top plan view of the top of a glue trap barrier oriented in a square shape, specifically to be used to surround a known hotspot for mice, such as a bowl of dog food. This configuration is achieved by orienting two chains parallel to one another, and then overlapping two more chains perpendicular to the first two chains, such that each end of the second two chains overlaps slightly with the ends of each of the first two chains. The overlaps are each denoted O.

1. A glue trap of longer/variable length that acts as a barrier to rodents and pests comprising of:
a. A series of individual boards (paper, plastic, cardboard, or another functional, sturdy material) connected by perforation
b. A layer of non-drying glue deposited on said series of boards that completely spans the length of the boards along the longest dimension, but leaves a narrow strip of space without glue on either side of the layer of glue, also spanning the longest dimension, for ease of handling

2. A glue trap further comprising an accordion-style means of packaging and storing, wherein the individual boards fold on top of one another, hinging at the perforation

3. A method for trapping rodents and other pests as described in the following steps:
a. Providing a series of individual boards connected by perforation and depositing a layer of glue on said boards that completely spans the length of the boards along the longest dimension (as described in claim #1)
b. Sizing said barrier to fit a desired location by tearing along the perforation
c. Placing said sized barrier in a desired location in order to trap rodents and other pests

4. A method for trapping rodents and other pests as described in the following steps:
a. Providing a series of individual boards connected by perforation and depositing a layer of glue on said boards that completely spans the length of the boards along the longest dimension (as described in claim #1)
b. Sizing two or more of said barriers to fit a desired location by tearing along the perforation
c. Attaching the barriers to one another to form a larger barrier by adhering the first board of one chain to the last board of another chain, with the bottom of the first board of one chain overlapping with the last board of the other chain, hence adhering via the sticky surface on the top of the bottom board, and repeating said process to further connect more barriers if necessary, in order create a longer straight line, an L-shape, a square, or whatever configuration is desired
d. Placing said sized, attached barriers in a desired location in order to trap rodents and other pests

5. A method for trapping rodents and other pests in hard-to-reach places as described in the following steps:
a. Providing a series of individual boards connected by perforation and depositing a layer of glue on said boards that completely spans the length of the boards along the longest dimension (as described in claim #1)
b. Sizing said barrier to fit a desired location, perhaps under a stove or refrigerator, by tearing along the perforation
c. Sliding said sized barrier into the hard-to-reach area in order to trap rodents and other pests

6. A method for trapping rodents and other pests as described in the following steps:
a. Providing a series of individual boards connected by perforation and depositing a layer of glue on said boards that completely spans the length of the boards along the longest dimension (as described in claim #1)
b. Tearing off a single board and glue trap from said barrier along the perforation
c. Placing said board and glue trap in a desired location in order to trap rodents and other pests

7. A method for removing and replacing individual traps within said barrier as described in the following steps:
a. Removing the desired individual trap from the barrier, most likely because it has trapped a rodent or pest, by tearing along the perforation on either side
b. Replacing said trap with another individual trap by adhering the replacement trap onto the chain, with the bottom of the replacement trap slightly overlapping with the surface of the boards on either side, and hence adhering via the sticky surface of the boards on either side, resulting in the restored continuity of the barrier
